(19) United States
(12) Patent Application Publication
(10) Pub. No.: US 2025/0382806 A1
(43) Pub. Date: Dec. 18, 2025

(54) METHOD AND SYSTEM FOR DETECTING A STRUCTURE OF A SCAFFOLD

(71) Applicant: Axel MAHLO, Berlin (DE)

(72) Inventors: Axel MAHLO, Berlin (DE); Gerd RAICH, Graz (AT)

(21) Appl. No.: 18/877,719

(22) PCT Filed: Jun. 22, 2023
(86) PCT No.: PCT/EP2023/067033

§ 371 Date: Dec. 20, 2024

(30) Foreign Application Priority Data
Jun. 28, 2022 (EP) 22181498.1

(51) Int. Cl. E04G 5/00; G06K 19/07; G06Q 50/08

(52) U.S. Cl. CPC E04G 5/007; G06K 19/0723; G06Q 50/08

(57) ABSTRACT

The method of detecting an erection of a scaffold comprises: providing scaffold components, attaching RFID elements to the scaffold components, wherein article master data relating to the associated scaffold component are stored in the RFID elements, providing a portable RFID reader designed for reading out the article master data stored in the RFID elements within its detection range, providing a computer unit communicating with the RFID reader, erecting the scaffold with the scaffold components by scaffolders equipped with the RFID reader, reading out the article master data stored in the RFID elements during the erection of the scaffold and transmitting the read-out article master data to the computer unit, identifying the scaffold components used for the erection of the scaffold and their mutual connection from the received article master data and creating a virtual image of the scaffold from the identified scaffold components using the computer unit.

### BACKGROUND

The invention refers to a method that can be used to detect the structure of a scaffold by enabling the creation of a virtual image of the scaffolding. The invention also refers to a system that can be used to detect the structure of the scaffolding.

In the field of structural engineering, scaffolds are an integral part of the construction or renovation of buildings or industrial plants. Modern scaffolds include many different scaffolding components, which are connected to create a modular system as the scaffold is erected. In this way, scaffolding can be adapted to meet the requirements on different construction sites, whereby scaffolds can be constructed to reach very great heights.

One challenge faced when erecting a scaffold is that the scaffolding must be erected in accordance with a specified design plan or erection procedure to ensure the necessary stability. A stability certificate serves as verifiable proof that the scaffolding has been correctly erected, and this certificate must include the manufacturer information, type tests, and applicable standards, among other things. Particularly when very large scaffolding is constructed on large construction sites or industrial plants, however, the scaffolding is continuously being extended, and other parts of the scaffolding may even be dismantled in the project phase. Nevertheless, the scaffold must meet the necessary stability requirements at all times.

Another current challenge faced when erecting scaffolding is associated with asset management and crew planning. In order to ensure that the erection process runs smoothly on the construction site or at the industrial plant, it is helpful to have up-to-date information about the material utilization and composition at all times. This is also essential for project management, since this allows progress reports to be created, team planning to be carried out, and performance indicators to be generated for the various contractors and/or companies involved. Invoicing in large projects is also sometimes highly complex; thus, it is desirable to find a way to automatically and consistently record the materials and track the progress of the erection work, including the approvals for the scaffold use. It is also desirable and even necessary in modern projects to be able to rent the scaffolding to individual contractors or companies and to invoice this individually.

Prior art scaffolding does not allow this or, if so, then only with great effort.

Document DE 200 05 975 U1 describes formwork and scaffolding components which can be used on a construction site and can be identified by a special feature, namely by transponders attached directly to the components that provide identifying information for each component. This identifying information is used to keep an inventory of the formwork or scaffolding components before the structure is erected and after it is dismantled. This ensures that a record is kept of the number of formwork or scaffolding components made available and of how long they have been available, enabling project managers to check whether the parts that were made available or older or damaged parts of the same or similar type are returned. Attaching transponders to these components enables the identifying features of each component to be recorded wirelessly using a portable or stationary reader. This simplifies the recording process and even makes it possible when the parts are stacked on top of each other for transportation. The identifying features are not recorded by the scaffolders, but are recorded before the scaffolding is erected and a second time after the scaffolding has been dismantled. The identifying features are only recorded for the purposes of inventorying the formwork or scaffolding components. In particular, it is not intended to use the identifying features to record the scaffolding erection process and to create a virtual image of the scaffolding, which depicts all individual scaffolding components used and how they are connected to each other based on their identifying features.

Document WO 2022/098630 A1 does not address the field of scaffold construction, but describes how to inventory objects, namely tintable windows in an already completed building, and how to cross-check whether an existing electronic inventory of these objects corresponds to the real inventory. After the building has been constructed, a person or a drone is sent around the building to record the objects that have actually been installed. The objects recorded by this person or drone can then be compared with the electronic inventory.

### BRIEF SUMMARY

The invention is therefore based on the fact that a method and a system are provided for detecting whether a scaffold has been (properly) erected. This method and system avoid the above-mentioned disadvantages associated with the current practices. In particular, the invention is intended to help ensure that the scaffolding has the necessary stability during its erection and to be able to verify the stability of the erected scaffold at any time.

The invention solves the problem, namely the need for a method that can be used to detect the structure of a scaffold, and comprises the following steps:
Providing scaffolding components;
Attaching RFID tags to the scaffolding components, whereby the master data for the associated scaffolding components will be stored on RFID tags before or after they are attached to the respective scaffolding components;
Providing at least one portable RFID tag reader, which is designed to read the component master data stored on the RFID tags within its detection range;
Providing a processor unit designed for wireless communication with the at least one RFID tag reader;
Erecting the scaffold with the scaffolding components by scaffolders, whereby at least one scaffolder is equipped with the RFID tag reader;
Recording the component master data stored in the RFID tags on the scaffolding components during their assembly and transferring the recorded component master data to the processor unit; and
Identifying which scaffolding components are used during their assembly and how they are connected to each other based on the component master data received from at least one RFID tag reader and creating a virtual image of the scaffolding from the scaffolding components identified using the processor unit.

Preferably, these steps will enable at least the identification of the scaffolding components used during their assembly and their connections to each other, as well as the creation of a virtual image of the scaffolding, in real time. Optionally, these steps will also enable the component master data to be recorded and transferred to the processor unit, also in real time.

If the virtual image of the scaffolding is stored in a data storage space accessible via a computer network or a remote data connection, and preferably in cloud storage, the image can be used by people and companies involved in the project and evaluated in various ways. For example, it can be used to create the necessary reports and documents, carry out static tests and documentation, make inventories, and calculate the cost of using the scaffold. Creating a virtual image of the scaffolding also makes it possible to invoice the work required for the scaffolding erection and/or dismantling according its components and/or its area and/or its volume. This calculation process can even be automated based on the virtual image of the scaffolding.

There are even more ways to use and evaluate the virtual image of the scaffolding if the component master data include information about at least the component type and/or its length as well as optional administrative information, such as the manufacturer and the production date of the scaffolding component.

Scaffolding components are usually manufactured according to national or international standards. These standards specify which types of scaffolding components can be provided, such as vertically arranged, tubular, load-bearing elements known as “uprights” or “standards”, frame beams, and diagonally arranged elements known as “braces”. The latter, as truss elements, do not bear loads directly but transfer them to other scaffolding components, and particularly to horizontal elements known as “ledgers”, scaffolding legs, the base jacks or plates, shoring heads, decks (also known as “battens”), access decks, ladders, etc. The standards also specify the length of at least some of the scaffolding components mentioned, as well as grid spacing dimensions that serve as references when scaffolding components are connected to each other. In order to comply with such grid spacing dimensions, scaffolding components, such as standards, beams, and frame elements, usually have several connection points spaced apart from each other according to grid spacing dimensions, at which they can be connected to other scaffolding components.

For example, standards and frame beams intended for vertical arrangement have connection points where they can be connected to horizontal ledgers or diagonal braces. For this reason, a preferred embodiment of the invention would involve the attachment of numerous RFID tags to at least some of the scaffolding components, where these tags are arranged either at or near predefined connection points between the scaffolding components and other scaffolding components. Optionally, the connection point associated with the RFID tag can be identified on the basis of the component master data on the RFID tag. In the scaffolding industry, these connection points are also referred to as nodes or system connection points. In a further embodiment of this invention, the detection range of the RFID reader is configured so that it can only detect a limited number (e.g. only one) of several RFID tags attached to a scaffolding component. This enables the creation of the virtual image of the scaffolding, because the connection point of a scaffolding component can be detected by using the RFID reader, and the possible connection(s) with other scaffolding components can be clearly defined or easily identified by using the evaluation software.

In a preferred embodiment of the method according to the invention for tracking the erection of the scaffolding, a plausibility check is intended. When creating the virtual image of the scaffold, the user takes into account which types of scaffolding components can be connected to one another and, if necessary, at which connection points, and in which position the types of scaffolding components can be installed in the scaffolding. Only those scaffolding components which fulfill these criteria are considered when creating the virtual image of the scaffolding. The information required to perform this plausibility check to evaluate whether the scaffolding components can be connected to one another and the possible positions of the scaffolding components can be stored in a database, which is accessed when the virtual image of the scaffolding is created. This information can also be stored in the form of predefined algorithms that are executed by the computer unit when the virtual image of the scaffolding is created. Finally, this information can also be generated by programs based on artificial intelligence, and in particular self-learning programs, which are executed by the computer unit. When executing the algorithms or the programs based on artificial intelligence, these programs search for evidence for the presence of attachments. In a further embodiment of the invention, additional information can be manually entered into the programs. For example, when erecting the scaffolding, it may be necessary for structural reasons to avoid a direct connection between a diagonal element (brace) and a vertical standard or horizontal ledger. Such a non-standard attachment can then be evaluated manually and this information can be transferred to update the virtual image of the scaffolding. Additional plausibility checks can also be defined based on the component master data.

In a further embodiment of the invention, only the scaffolding components that are actually already part of the scaffolding are used to create the virtual image of the scaffolding, but not those components which are still being transported to the position where they will be installed (i.e., either being carried by the scaffolder or moved by cranes). This precaution ensures that, when creating a virtual image of the scaffolding from the identified components, only those scaffolding components are considered which do not move significantly in relation to one another or which are in static positions in relation to one another. The positions of these components should preferably be determined by recording the master data stored on the RFID tags several times at various intervals and by comparing the recorded component master datapoints. In this way, RFID tags storing component master data which are recorded for the first time or which can no longer be recorded are not considered to fulfill the criterion that the associated scaffolding component does not move significantly.

To apply the method as described in the invention, the invention also provides a system for detecting a scaffolding structure. This comprises:
Scaffolding components;
RFID tags that can be attached or are attached to the scaffolding components, whereby the master data related to each associated scaffolding component can be stored on the RFID tags before or after they are attached to these components; and
At least one transportable RFID reader which is designed to record the component master data stored on the RFID tags within its detection range, at least one computer unit which is designed for wireless communication with at least one RFID reader, where the computer unit has a processor, program memory, data memory, and a communication interface that enables communication with the RFID reader.

Preferably, it should be possible to attach the portable RFID reader to the scaffolder's work clothing or integrated into the work clothing, so that it does not interfere with the scaffolder's difficult work. Ideally, the scaffolder should not even notice the RFID reader during their work.

The RFID reader should preferably be designed as an active RFID tag with an antenna. Such active RFID tags are provided with a built-in power supply (e.g., batteries or rechargeable batteries), as is well-known in the field.

The RFID tags should also preferably be designed as passive RFID tags. Such passive RFID tags are available from a large number of manufacturers. These do not have their own power supply, but are supplied with energy for data transmission via the electromagnetic field emitted by the RFID reader. Passive RFID tags have additional advantages in that they are small, cheap, and robust.

Active and passive RFID tags are well-known to those skilled in the art and, therefore, require no further explanation.

The RFID reader preferably has a user interface that enables data to be manually entered. This allows the scaffolder to enter data during the erection of the scaffolding. This is useful because it allows the creation of a virtual image of the scaffolding, for example, to illustrate a non-standard arrangement of certain scaffolding components in relation to other scaffolding components.

In order to further use and evaluate the created virtual image of the scaffold, it is advantageous if the computer unit is configured in a way that allows access to this virtual image via a computer network or via a remote data connection with a data storage device, and preferably a cloud storage device.

The invention also encompasses a computer program with instructions that cause the customized system to perform the steps of the customized method when the computer program is loaded into the computer unit's program memory. The computer program can be stored on data carriers for distribution and execution in the computer unit, but it can also be transmitted by means of a data carrier signal.

### BRIEF DESCRIPTION OF THE DRAWINGS

The invention will now be explained in more detail by making specific reference to the drawings. These drawings show:

FIG. 1, which is a schematic representation of scaffolding under construction according to the invention;

FIG. 2, which is a schematic representation of the system according to the invention; and

FIG. 3, which is a schematic representation of the computer unit and the programs executed by it.

### DETAILED DESCRIPTION

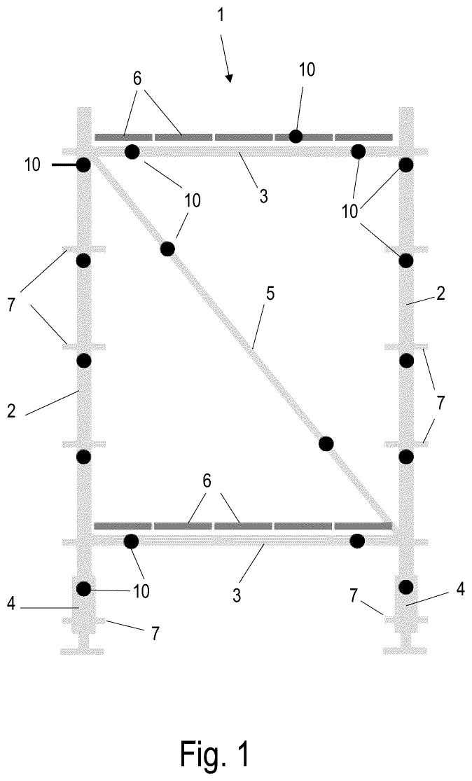

Referring to FIG. 1, the scaffolding 1 which is being erected will be described first, whereby only a representative section of the scaffolding 1 is shown in FIG. 1. The scaffolding consists of various types of components numbered 2-6, namely vertically arranged standards (i.e., uprights) 2, which are connected to horizontal ledgers 3, and a diagonal brace 5, as well as the decks 6 which are placed on the horizontal ledgers 3 and scaffolding feet 4, upon which the standards 2 rest. The scaffolding feet 4 are fitted with base jacks to allow for height compensation on uneven surfaces. Although only some of the possible types of scaffolding components can be seen in this figure, it is understood that scaffolding 1 according to the invention comprises all the typical scaffolding components, which can be combined with one another depending on the conditions found at the erection site. The standards 2 and the scaffolding feet 4 are provided with connection points 7. These are designed, for example, as flanges to which other scaffolding components can be connected. The distances between the connection points 7 are standardized and are usually 0.5 m.

The uprights 2, the ledgers 3, the scaffold feet 4, the brace 5, and the decks 6 are provided with RFID tags 10, which store the master data for each respective scaffolding component. It should be noted that the uprights 2, ledgers 3, and brace 5 are each provided with several RFID tags 10, which are positioned at or near the connection points 7 for these scaffolding components. In addition to the master data for the scaffolding component, these tags also contain information about the connection point 7 to which they are attached. The scaffolding legs 4 and the decks 6 only have one RFID tag 10. Typical component master data include at least the type of scaffolding component and/or its length, as well as optional administrative data, such as the manufacturer and the production date of the scaffolding component. The RFID tags 10 are designed as passive RFID tags.

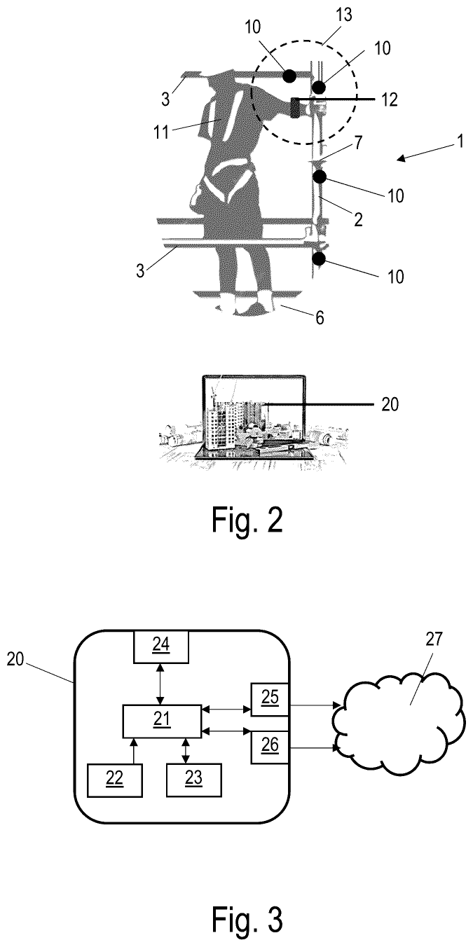

FIG. 2 schematically illustrates how the scaffolding 1 is assembled by a scaffolder 11. The scaffolder 11 stands on a deck 6 and has already connected uprights 2 and ledgers 3, each of which has RFID tags 10 containing master data for the respective scaffolding components 2, 3. The scaffolder 11 carries an RFID reader 12 on their arm. This reader is designed to record the component master data from RFID tags 10 within its detection range 13. In this exemplary embodiment, the portable RFID reader 12 is built into a wristband that the scaffolder 11 has wrapped around their forearm. Alternatively, the RFID reader 12 can also be embedded directly in the scaffolder's 11 work clothing, for example, in a glove. The RFID reader 12 is designed as an active RFID tag and is configured so that its detection range 13 is so narrow that it can only detect a limited number of the RFID tags 10 on one scaffolding component 2-6 at a time.

While the scaffolding is being erected, the RFID reader 12 is used to record data stored on the RFID tags 10 located within its detection range 13 either continuously or at predetermined intervals. The reader transmits the recorded component master data wirelessly to a computer unit 20. In addition, the RFID reader 12 is equipped with a user interface (e.g., buttons) that can be used to manually enter data. These manually entered data are also transmitted by the RFID reader to the computer unit 20. In another embodiment of the invention, the RFID reader 12 can be integrated into a device similar to a smartphone. Software applications can be run on this device, and the scaffolder 11 can control the software applications via the device's touch-sensitive display. By using this software application, the scaffolder 11 can transmit all information about the scaffolding 1 and also record this information for their personal use. This information may include the general conditions to be complied with, the number of scaffolders 11 involved in the erection process, the weather, current images of the scaffolding, the building, or the surroundings.

As shown schematically in FIG. 3, the computer unit 20 has a processor 21, a program memory 22, a data memory 23, and a communication interface 24 that allows communication with the RFID reader 12. Furthermore, the computer unit 20 can have a network interface 25 and/or an interface 26 that allows the establishment of remote data connection (e.g., a radio telephone interface), data communication with a data storage device 27, and in particular cloud storage. The computer unit 20 can be, for example, a computer, a laptop, or a smartphone.

The computer unit 20 determines which scaffolding components 2-6 are used when assembling the scaffolding 1 and how these components are connected to each other on the basis of the component master data received from the RFID reader 12. Based on this information, it creates a virtual image of the scaffolding 1. The computer unit sends the created virtual image of the scaffolding 1 via the network interface 25 and/or the interface 26 that allows the establishment of a remote data connection to a data storage device 27—in the present embodiment example, cloud storage—where the virtual image of the scaffolding can be used for analyses, reports, tests, etc.

When creating the virtual image of the scaffolding 1, the computer unit 20 performs plausibility checks, which take into account which types of scaffolding components 2-6 can/may be connected to each other. If needed, the unit can determine how the scaffolding components 2-6 can be connected to each other at which connection points 7 and whether the recognized types of scaffolding components 2-6 are installed in the scaffolding 1 in acceptable positions. When creating the virtual image of the scaffolding, only scaffolding components 2-6 that fulfill these criteria are taken into account.

The principle of the present invention is that the relative positions of the scaffolding components 2-6 are recognized by recording their component master data from the RFID tags 11. In the situation shown in FIG. 2, the RFID reader 12 reads an RFID tag 10 on the upright 2 and an RFID tag 10 on the ledger 3. These data indicate that these two scaffolding components 2, 3 are connected to each other. If the recorded component master data also contain information that reveals where the RFID tags 10 are positioned on the scaffolding components 2, 3, it becomes easier to create the virtual image of the scaffolding 1, but this information is not absolutely necessary. This is because the scaffolder 11 moves around the scaffolding 1 during its erection, which means that different groups of RFID tags 10 that fall within the RFID reader's 12 detection range 13 are continually being detected. The complete image of the scaffolding can be compiled and constantly monitored based on these different groups of RFID tags 10 or their component master data. In addition, the scaffolder 11 can manually enter additional information into the RFID reader 12 which is helpful for creating the virtual image of the scaffolding 1.

To ensure that only those scaffolding components 2-6 are detected which have already been installed in the scaffolding 1 (i.e. those that do not move or move only slightly in relation to each other), the component master data is recorded several times at short time intervals and compared with each other. During this process, data from the RFID tags 10 are recorded several times if they are within the detection range 13 of the RFID reader 12 and attached to scaffolding components 2-6 that do not move.

The information required for the plausibility checks about how the scaffolding components 2-6 are connected and which positions the scaffolding components 2-6 may have can be stored in a database (not shown). The computer unit 20 accesses this information when creating the virtual image of the scaffolding 1. This information can also be stored in the form of predefined algorithms which are, in turn, stored in the program memory 22 of the computer unit 20 when the virtual image of the scaffolding 1 is created. These algorithms are executed by the processor 21. Finally, this information can also be generated by programs based on artificial intelligence, and in particular self-learning programs, which are executed by the computer unit 20. The information can also be acquired by combining these strategies.

The created virtual image of the scaffolding 1 offers the advantage that all component master data for the scaffolding components 2-6, the positions of all installed parts, the erection or dismantling progress and activities, and the allocation to or use of individual contractors or companies can be centrally stored. Every change in the scaffolding 1 is registered in real time using the method according to the invention and is reflected by the virtual image. The virtual image can be made centrally available to all companies involved in the construction process. The fact that a virtual image of the scaffolding can be created or updated in real time thus represents a major advance over previous planning models. If the scaffolding needs to meet special requirements (load-bearing scaffolding and/or scaffolding above a certain height or with greater complexity), scaffolding models can be planned in advance and implemented on site. Of course, this model does not allow the user to determine whether the structure created corresponds to the model as planned; the scaffold must be checked for conformity by comparing it with the model once the erection process is complete and, if necessary, the plan must be adjusted or the scaffold must be modified if any differences are detected.

In contrast to the current situation, the virtual image of the scaffolding created according to the invention reflects the reality at all times. In addition, all companies involved in the project also ideally receive a progress report. The responsible company can coordinate with companies or contractors who use the scaffolding 1 during the course of the project and rent it out or invoice it individually to these companies or contractors. The companies involved in the project also ideally receive real-time information about the scaffolding components 2-6 currently being used, which can then be used to determine which scaffolding components are still in stock. Thanks to the availability of a real-time inventory, scaffolding components can be reordered whenever needed. This prevents material supply bottlenecks and also reduces the costs that would be incurred if too much material were kept in stock. Because it is possible to measure erection and dismantling times using an automated method, the performance of individual erection teams or companies can be compared, and individual key performance indicators can be created. These data can be used for bid optimization and crew planning. Scaffolding manufacturers can also create safety certificates based on the virtual image and take on-site changes into account without incurring delays. Companies providing scaffolding erection and dismantling services can be involved in the project in real time and their resources can be adjusted if necessary.

In addition, scaffolding components 2-6 can no longer be removed from the scaffold 1 without their removal being noticed. This prevents the structure from collapsing. Any differences between the existing structure and the one associated with the previously issued safety certificate can be automatically registered and are reflected in the virtual image.

1-17. (canceled)

18. A method of detecting an erection of a scaffold, comprising steps of:
providing scaffold components;
attaching RFID elements to the scaffold components, wherein each of the scaffold components is associated with article master data and wherein the article master data relating to the associated scaffold component are stored in the RFID elements before or after the RFID elements are attached to the scaffold components;
providing at least one portable RFID reader designed for reading out the article master data stored in the RFID elements within a detection range;
providing a computer unit designed for wireless communication with the at least one RFID reader;
erecting the scaffold with the scaffold components by scaffolders, with at least one scaffolder being equipped with the RFID reader;
reading out the article master data stored in the RFID elements of the scaffold components during the erection of the scaffold and transmitting the article master data read from the RFID elements to the computer unit; and
identifying the scaffold components used for the erection of the scaffold and their mutual connection from the article master data received by the at least one RFID reader and creating a virtual image of the scaffold from the identified scaffold components using the computer unit, wherein at least the identification of the scaffold components used for the erection of the scaffold, their mutual connection and the creation of the virtual image of the scaffold, and the reading-out and transmission of the article master data to the computer unit, occur in real time.

19. The method according to claim 18, further comprising providing the virtual image of the scaffold for further usage and evaluation in a data storage device accessible via a computer network or a remote data connection including a cloud storage device.

20. The method according to claim 18, wherein the article master data comprise at least a type of scaffold component and/or a length of the scaffold component.

21. The method according to claim 18, wherein at least some of the scaffold components are provided with several RFID elements which are arranged at or near predefined connection points of the scaffold components with other scaffold components, wherein a marking of the connection point to which the RFID element is assigned is stored in the article master data of the RFID element.

22. The method according to claim 21, wherein the detection range of the RFID reader is configured such that the RFID reader can always detect only a limited number of several RFID elements attached to a scaffold component.

23. The method according to claim 18, wherein, when creating the virtual image of types of scaffold components that are connectable to each other accounted for and, if applicable, at which connection points and in which position the types of scaffold components can be installed in the scaffold, with only those scaffold components that meet these criteria being taken into account when creating the virtual image of the scaffold.

24. The method according to claim 23, wherein information about the connectability of the scaffold components and possible positions of the scaffold components is stored in a database which is accessed when creating the virtual image of the scaffold, and/or the information is stored in predefined algorithms that are executed in the computer unit when creating the virtual image of the scaffold, and/or the information is generated by programs based on artificial intelligence, which are executed in the computer unit.

25. The method according to claim 18, wherein, when creating the virtual image of the scaffold from the identified scaffold components, only those scaffold components are taken into account that do not move significantly in relation to each other, which is determined by reading in the article master data several times at time intervals and comparing the article master data that have been read in.

26. A system for detecting an erection of a scaffold, comprising:
scaffold components,
RFID elements attachable or attached to the scaffold components, wherein article master data relating to the associated scaffold component are storable in the RFID elements before or after the RFID elements are attached to the scaffold components,
at least one transportable RFID reader designed for reading out the article master data stored in the RFID elements within its detection range,
at least one computer unit designed for wireless communication with the at least one RFID reader, the computer unit having a processor, a program storage device, a data storage device and a communication interface for communication with the RFID reader,
the system being configured to perform the steps of the method according to claim 18.

27. The system according to claim 26, wherein the portable RFID reader is attachable to work clothing of a scaffolder or is integrated into the work clothing or is worn as a separate cuff.

28. The system according to claim 26, wherein the RFID reader is designed as an active RFID tag with an antenna.

29. The system according to claim 26, wherein the RFID elements are designed as passive RFID tags.

30. The system according to claim 26, wherein the RFID reader comprises a user interface for manual data entry.

31. The system according to claim 26, wherein the computer unit is configured to communicate with a data storage device or a cloud storage device, via a computer network or a remote data connection.

32. A computer program comprising commands for performing the steps of the method according to claim 18 when the computer program is uploaded into a program storage device of a computer unit of a system comprising:
scaffold components,
RFID elements attachable or attached to the scaffold components, wherein article master data relating to the associated scaffold component are storable in the RFID elements before or after the RFID elements are attached to the scaffold components,
at least one transportable RFID reader designed for reading out the article master data stored in the RFID elements within its detection range,
at least one computer unit designed for wireless communication with the at least one RFID reader, the computer unit having a processor, a program storage device, a data storage device and a communication interface for communication with the RFID reader.

33. A data carrier on which the computer program according to claim 32 is stored.

34. The method of claim 20, wherein the article master data comprise administrative data including a manufacturer and a date of production of the scaffold component.
